(19) United States
(12) Patent Application Publication
(10) Pub. No.: US 2017/0262587 A1
(43) Pub. Date: Sep. 14, 2017

(54) METHOD AND SYSTEM FOR GENERATING PATIENT PROFILES VIA SOCIAL MEDIA SERVICES

(71) Applicant: Xerox Corporation, Norwalk, CT (US)

(72) Inventors: Arvind Agarwal, New Delhi (IN); Stuti Awasthi, Noida (IN); Saurabh Singh Kataria, Rochester, NY (US); Veerasundaravel Thirugnanasundaram, Webster, NY (US)

(21) Appl. No.: 15/065,424

(22) Filed: Mar. 9, 2016

(51) Int. Cl. G06F 19/00; G06Q 50/00

(52) U.S. Cl. CPC G06F 19/325; G06F 19/322; G06Q 50/01; G06F 19/345; G06F 19/3431

(57) ABSTRACT

A method and non-transitory computer readable medium for generating patient profiles via a social media service are disclosed. For example, the method receives data from the social media service, extracts one or more attributes from the data from the social media service, classifies the one or more attributes to one or more of a plurality of predefined profile attributes, generates a patient profile based on the one or more attributes that are classified, determines a medical action to be executed based on the patient profile and transmits the medical action to be executed to a health administration server.

The present disclosure relates to generating patient profiles and, more particularly, to a method and a system for generating patient profiles via social media services.

### BACKGROUND

Advances in Internet and mobile technologies have changed the way people access, use and share information. For example, social media platforms allow users to document their experiences at various different levels of detail. As a result, social media services have become a popular and convenient platform for users to express their problems, discuss these problems, and seek information and answers to their questions.

However, social media services provide an abundant amount of data. Users may post several messages a day. There may be millions of users per day. Thus, sorting the large amounts of data for relevant information and organizing the data into a format that is useful for a particular application can be very difficult.

### SUMMARY

According to aspects illustrated herein, there are provided a method and a non-transitory computer readable medium for generating patient profiles via a social media service. One disclosed feature of the embodiments is a method comprising receiving data from the social media service, extracting one or more attributes from the data from the social media service, classifying the one or more attributes to one or more of a plurality of predefined profile attributes, generating a patient profile based on the one or more attributes that are classified, determining a medical action to be executed based on the patient profile, and transmitting the medical action to be executed to a health administrator server.

Another disclosed feature of the embodiments is a non-transitory computer-readable medium having stored thereon a plurality of instructions, the plurality of instructions including instructions, which when executed by a processor, cause the processor to perform operations comprising receiving data from the social media service, extracting one or more attributes from the data from the social media service, classifying the one or more attributes to one or more of a plurality of predefined profile attributes, generating a patient profile based on the one or more attributes that are classified, determining a medical action to be executed based on the patient profile, and transmitting the medical action to be executed to a health administrator server.

Another disclosed feature of the embodiments is a method for generating patient profiles via a social media service comprising receiving data from the social media service for a plurality of different patients, preprocessing, the data for a plurality of different patients, extracting one or more attributes for each one of the plurality of different patients from the data from the social media service, classifying the one or more attributes or one of a plurality of predefined profile attributes for each one of the plurality of different patients, generating a patient profile for each one of the plurality based on the one or more attributes that are classified, extracting one or more events from the patient profile, classifying the one or more events to one or more of a plurality of predefined profile events, identifying temporal relationships among the one or more events that are classified, creating, by the processor, a timeline based on two or more patient profiles for the each one of the plurality of different patients, generating a disease progression model based on the each one of the plurality of different patients, determining, by the processor, a medical action to be executed based on the each one of the plurality of different patients, and transmitting the medical action to be executed.

### BRIEF DESCRIPTION OF THE DRAWINGS

The teaching of the present disclosure can be readily understood by considering the following detailed description in conjunction with the accompanying drawings, in which:

FIG. 1 illustrates a block diagram of an example system of the present disclosure;

FIG. 2 illustrates an example apparatus of the present disclosure;

FIG. 3 illustrates an example patient profile of the present disclosure;

FIG. 4 illustrates an example disease progression model of the present disclosure;

FIG. 5 illustrates a flowchart of an example method for generating a patient profile via a social media service; and

FIG. 6 illustrates a high-level block diagram of a computer suitable for use in performing the functions described herein.

To facilitate understanding, identical reference numerals have been used, where possible, to designate identical elements that are common to the figures.

### DETAILED DESCRIPTION

The present disclosure broadly discloses a method and non-transitory computer-readable medium for generating patient profiles via a social media service. As discussed above, advances in Internet and mobile technologies have changed the way people access, use and share information. As a result, social media services have become a popular and convenient platform for patients to express their problems, discuss these problems, and seek information and answers to their questions. For example, patients can learn about another patient's medical condition, treatment, quality of care, or diagnosis. However, social media services provide an abundant amount of data, thus overloading the patient with information and making the social media information less useful and effective.

Data found on social media services is useful when there is effective communication among patients. Quality of support and information sought by patients increase when communication takes place between two patients who are relatively similar and have gone through a similar medical situation. Currently, patient similarity has not been computed using data generated from social media services. As a result, using patient similarity to recommend patients based on similar experiences has been difficult to develop.

Additionally, disease progression models have been historically based on evidence based guidelines and the results of clinical tests. However, data from social media services has not been used to build disease progression models. Furthermore, using these disease progression models to analyze and understand various stages of disease progression, as well as optimize the quality of treatments for subjects, has been difficult to develop.

Embodiments of the present disclosure provide a novel method for generating patient profiles via a social media service to provide a recommendation to the patient based on the similarity between two or more patients and additionally, to provide a diagnosis and a treatment for subsequent patients based on a disease progression model. As a result, the recommendation provides a group of highly similar patients and helps increase patient-patient interaction for improved communication. As a result, the generated patient profiles can be used for other analytical tasks such as risk stratification, severity alert prediction and remote patient monitoring. The disease progression model can also be used for conditional anomaly detection methods, improving pharmaceutical research and development activity, optimizing treatment, designing clinical guidelines, risk stratification, severity alert prediction, and patient readmission prediction.

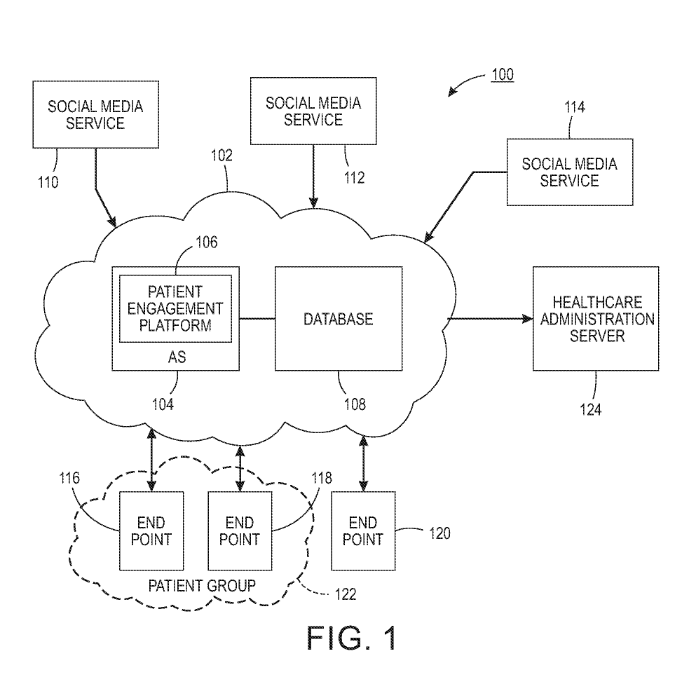

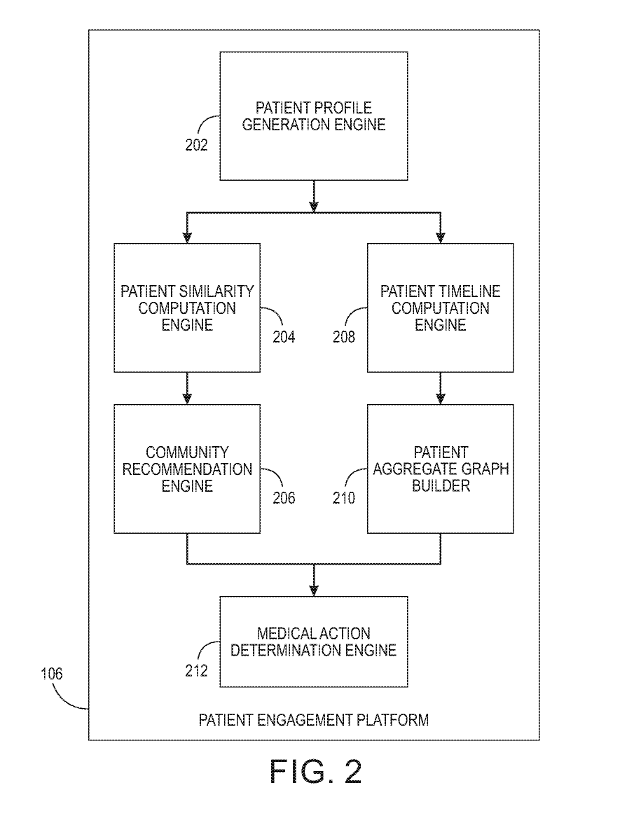

FIG. 1 illustrates an example system 100 of the present disclosure. In one embodiment, the system 100 includes a communications network 102, an application server (AS) 104 having a Patient Engagement Platform (PEP) 106 and a database (DB) 108. In one embodiment, the communications network 102 may be any type of communications network including, for example, an Internet Protocol (IP) network, a cellular network, a broadband network, and the like. The PEP 106 is discussed in further detail below in FIG. 2.

In one embodiment, one or more social media services 110, 112 and 114 may be in communication with the communications network 102. For example, the one or more social media services 110, 112 and 114 may be social media services such as Facebook®, Twitter®, Linkedin®, and the like, where subscribers of the social media services share their experiences. Social media services may also include forums, blogs and other webpages or websites where people share their experiences.

In one embodiment, the system 100 may include a patient group 122 having one or more endpoint devices 116 and 118 that are in communication with the communications network 102. In one embodiment, the patient group 122 may include one or more subscribers to social media services 110, 112 and 114 and associated with the endpoint devices 116 and 118. In one embodiment, the patient group 122 may be based on a similarity index, as discussed in further detail below. In one embodiment, the patient group 122 may be looking to target particular individuals based on patient profiles generated using social media services 110, 112 and 114. The AS 104 may communicate with the patient group 122 via endpoint device 116 or 118.

In one embodiment, the system 100 may include an endpoint device 120 that is in communication with the communications network 102. The endpoint device 120 may be subscribed to one or more of the social media services 110, 112 and 114. Although a single endpoint device 120 is illustrated in FIG. 1, it should be noted that any number of endpoint devices may subscribe to the one or more social media services 110, 112 and 114.

In one embodiment, the AS 104 and the DB 108 may be maintained and operated by a third party service provider. For example, the third party service provider may determine medical actions that should be taken for a hospital or health care provider associated with a health administration server (HAS) 124. In another embodiment, the AS 104 and the DB 108 may be maintained and operated by the same hospital or health care provider as the HAS 124.

In one embodiment, the AS 104 may determine a medical action that is to be executed based on the patient profile, as discussed in further detail below. For example, the AS 104 may collect data associated with a patient of the endpoint device 120 from the one or more social media services 110, 112 and 114 to generate a patient profile, as discussed in further detail below. The AS 104 may transmit a medical action to the health administration server (HAS) 124.

In one embodiment, the medical action may be for the HAS 124 to send an invitation to the patient associated with the patient profile to join patient group 122 based on a similarity index score, as discussed below. The invitation may be, but is not limited to, a link, an email, or any medium that may generate a response. In another embodiment, the medical action may be a treatment, a prescription, monitoring a patient due to a possible health risk based on similarity to a patient profile of another patient having the same health risk, and the like.

In one embodiment, the HAS 124 may be in communication with the AS 104 via the communications network 102. In one embodiment, the HAS 124 may be operated by an employee of a hospital or a corporate entity associated with the hospital. In another embodiment, the HAS 124 may be operated by a person or a corporate entity related to the leadership, management, or administration of public health systems, health care systems, or hospitals. In one embodiment, the social media services 110, 112 and 114, endpoint devices 116, 118 and 120, and health care administration server 124 may be in communication with communications network 102 via either a wired or wireless connection.

It should be noted that although three social media services 110, 112 and 114 are illustrated in FIG. 1, any number of social media services may be deployed. It should be noted that although a single HAS 124 is illustrated in FIG. 1, any number of health care administration servers may be deployed. It should be noted that although a single patient group 122 and three endpoint devices 116, 118 and 120 are illustrated in FIG. 1, any number of patient groups and endpoint devices may be deployed.

It should be noted that FIG. 1 is a block diagram that has been simplified. The system 100 may include other network elements and access networks that are not shown. For example, the communication network 102 may include other network elements such as a firewall, border elements, gateways, and the like. The communications network 102 may also have additional access networks between the social media services 110, 112 and 114, the endpoint devices 116, 118 and 120 and the HAS 124, such as for example, a cellular access network, a broadband access network, and the like.

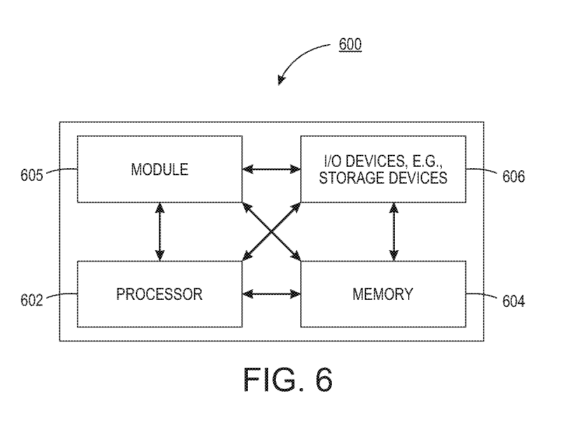

In one embodiment, the AS 104 may be deployed as a computer illustrated in FIG. 6 and described below and configured to perform the functions described herein. In one embodiment, the DB 108 may store information, such as for example, data generated by social media services 110, 112 and 114, locally stored dictionaries, patient profiles that are generated, disease progression models that are generated, and the like.

As noted above, the endpoints 116 and 118 in the patient group 122 and the endpoint 120 may be subscribers of a social media service 110, 112 and 114 that provides the data to the AS 104 having the PEP 106. The data may be used to generate a patient profile. The PEP 106 in the AS 104 then determines whether to execute a medical action based on the patient profile. In one embodiment, the medical action may be to recommend a patient group 122 or a patient having a patient profile that is similar to a patient associated with the endpoint device 120. In one embodiment, the medical action may include monitoring a patient for a health risk based on similarity to a patient profile of another patient that has the health risk. In one embodiment, the medical action may include predicting the impact of the disease and making a mortality prediction based on the similarity to a patient profile of another patient that has the disease.

In another embodiment, the patient profile may be used to create timelines and generate a disease progression model that can be used to determine a medical action. For example, the disease progression model may help doctors and patients understand various stages of a disease, symptoms, procedures, and repercussions of treatments. One embodiment of the PEP 106 is illustrated in FIG. 2.

FIG. 2 illustrates one example of the PEP 106 of the present disclosure. In one embodiment, the PEP 106 may include a patient profile generation engine 202, a patient similarity computation engine 204, a community recommendation engine 206, a patient timeline computation engine 208, a patient aggregate graph builder 210, and a medical action determination engine 212. In one embodiment, the PEP 106 may be deployed as a modified computer that is improved to perform the functions described herein as illustrated in FIG. 6 and discussed below.

In one embodiment, the patient profile generation engine 202 receives data from the social media service 110, 112 and 114. In one embodiment, the data is in free text form and is based on the natural language of the patient. In another embodiment, data is received from posts that are grouped from a given timestamp for a given patient. In one embodiment, data may be extracted from the original post in the social media service 110, 112 and 114. For example, these posts may contain details about the problem, mention the medication that the user is taking, list the procedures the user has undergone, or provide personal information about the user's family and financial situation.

In another embodiment, data is received from the original post and related posts in the social media service. For example, other users having experience with a similar problem may reply to an original post and this may trigger further discussion between the users. In one embodiment, the data is received from more than one patient.

In one embodiment, the patient profile generation engine 202 preprocesses the data from the social media service 110, 112 and 114, by performing standard textual clean up steps. For example, all posts from a single user may be aggregated. In another example, the preprocessing may include tokenization, lower-case conversion, removal of stop words, Part-Of-Speech tagging, shallow parsing or chunking. In another embodiment, the patient profile generation engine 202 preprocesses the data using more than one preprocessing technique. For example, the data may be preprocessed by first performing sentence detection and second by performing rule based tokenization.

In one embodiment, the patient profile generation engine 202 extracts one or more attributes from the data from social media service 110, 112 and 114 and classifies this data. For example, data may be classified for one or more attributes using standard dictionary lookup techniques. In one embodiment, the dictionary lookup technique may use the Unified Medical Language System (UMLS), Systematic Nomenclature of Medicine (SNOMED) or RxNORM dictionaries for medical entities annotation. In another embodiment, the dictionary lookup technique may use a standard dictionary, such as Merriam-Webster's, New Oxford American, and the like. In one embodiment, the attribute may be based on the Unified Medical Language System (UMLS). For example, the attribute may be classified into pre-defined attributes, such as diseases/disorders, signs/symptoms, anatomical sites, procedures, or medications. In another embodiment, the attribute may not be based on the UMLS. For example, the attribute may be classified into roman numerals, fractions, whole numbers, letters, symbols, and the like.

In one embodiment, the patient profile generation engine 202 may classify each attribute. In one embodiment, the patient profile generation engine 202 may classify each attribute for additional features based on the UMLS. For example, the medications attribute may be classified for additional features, such as dosage, duration, frequency, route, strength or change-status. In another embodiment, the patient profile generation engine 202 may classify each attribute for additional features that are not based on the UMLS.

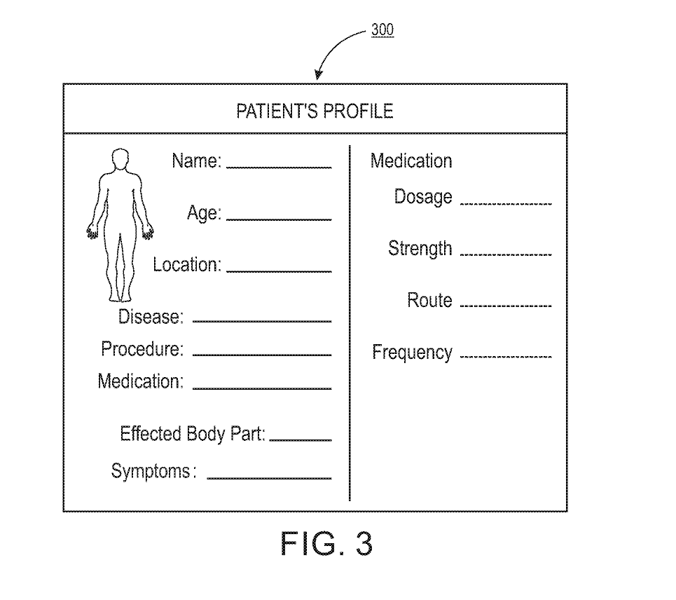

An illustration of an example of a patient profile 300 that is created by the patient profile generation engine 202 is shown in FIG. 3. The patient profile 300 may include other attributes, personal information and characteristics that are not shown. In one embodiment, the patient profile 300 may include the patient's name, age, location, disease, procedure, medication, effected body part or symptoms. The patient profile 300 may also include specific features for UMLS concepts. For example, medication may include dosage, strength, route or frequency.

In one embodiment, the patient profile generation engine 202 may generate the patient profile 300 by aggregating the attributes that are classified. In one embodiment, the PEP 106 may use the patient profile 300 for additional analysis that can be used to determine a medical action that should be taken. In one embodiment, the PEP 106 may use the patient profile 300 to compute a patient timeline via the patient timeline computation engine 208. In another embodiment, the PEP 106 may use the patient profile 300 to compute a similarity index via the patient similarity computation engine 204.

In one embodiment, the patient similarity computation engine 204 may compute a similarity index between two patients. For example, when new patient profiles are generated, the patient similarity computation engine 204 may compute the similarity index between the new patient and one or more existing patients.

In one embodiment, the patient similarity computation engine 204 may compute the similarity index by counting the number of common features in each patient profile. In one embodiment, the patient similarity computation engine 204 may calculate the similarity index by first assigning weights to each attribute in each patient profile using a word weightage scheme to capture the important attributes within the posts of social media service 110, 112 and 114. Examples of word weighting schemes include term frequency, term frequency-inverse document frequency, and the like. After weights are assigned to each attribute, the patient similarity computation engine 204 constructs a vector by combining the weights of each attribute. For example, the generated vector is:

pk=term1:W1,term2:W2 . . . , termn:Wₙ,

where each termₙ is associated with Wₙ.
After the data from the patient profile is transformed into a vector, the patient similarity computation engine 204 may calculate the similarity between two patients by taking the dot product of the weighted profile vectors.

In one embodiment, the patient similarity computation engine 204 may compute a similarity index between patient profiles and at least one additional patient profile using a cosine similarity distance. The cosine similarity distance determines how similar the vectors are to each other. To determine whether two vectors are similar to one another, a threshold value may be compared against the cosine similarity distance. For example, when the cosine similarity distance is less than the threshold value, the two vectors are similar. When the cosine similarity distance is greater than the threshold value, the vectors are not similar.

In one embodiment, the threshold value may be a predefined angular distance. For example, when the cosine similarity distance is less than the predefined angular distance, the two vectors are similar. When the cosine similarity distance is greater than the predefined angular distance, the two vectors are not similar. The patient similarity computation engine 204 may not be limited by the number of patient profiles, the number of posts, the number of terms, nor the number of vector representations.

In one embodiment, the community recommendation engine 206 may determine an additional patient based on the similarity index calculation via the patient similarity computation engine 204. The medical action to be executed that is determined by the medical determination engine 212 may be to instruct the HAS 124 to send a patient a communication (e.g., email) containing the additional patient's information based on the similarity index calculation. As a result, the patient will have another patient that he or she can communicate with and share experiences with concerning his or her medical condition. The communication is not limited to email and may include any medium for facilitating communications, such as a mailed letter, text message and the like.

In one embodiment, the community recommendation engine 206 may determine one or more recommended patient groups based on the similarity index calculation via the patient similarity computation engine 204. Thus, the medical action to be executed that is determined by the medical determination engine 212 may be to instruct the HAS 124 to send an invitation to a patient to join the patient group (e.g., the patient group 122) based on the similarity index calculation. As a result, the patient may have a group of patients that he or she can communicate with to obtain information or answers to questions about his or her medical condition.

In one embodiment, the community recommendation engine 204 may use a clustering algorithm to generate a group of patients having similar patient profiles. For example, clustering algorithms that may be used include k-means, hierarchical, or Balanced Iterative Reducing and Clustering Using Hierarchies (BIRCH). In one embodiment, clusters may be generated using an iterative process to converge centroids with minimum error. For example, the predefined range may be determined by using cosine similarities. In another example, the cosine similarity distance may be used as a baseline for a maximum value. After clusters are generated, the community recommendation engine 206 may determine an appropriate group to recommend to a patient based on the similarity between the vector associated with the patient and the centroid of the clusters.

In another embodiment, the patient profiles that are generated by the generation engine 202 may be used to generate one or more timelines. In one embodiment, the patient timeline computation engine 208 may be used to generate the timelines. In one embodiment, each timeline is presented as a directed acyclic graph (DAG). In one embodiment, attributes that were classified in patient profiles that were generated via patient profile generation engine 202 may be identified as events. In another embodiment, these events may be annotated using UMLS. In one embodiment, temporal relationships may be identified among events. For example, temporal events may include a date, a time, a year, a duration, or a frequency. In one embodiment, temporal ordering may be in the same ordering as it appears in the text. In one embodiment, timelines are created based on relationships between events and temporal entities. For example, there may be a relationship among clinical events. In another example, there may be a relationship among events and temporal entities. In one embodiment, the patient timeline computation engine 208 creates a timeline after relationships between events and temporal entities have been determined. In one embodiment, each timeline generated may be a DAG showing the sequence of events in chronological order that have happened during the patient's disease development cycle. In one embodiment, two or more timelines are represented as DAGs and created via the patient timeline computation 208. The two or more timelines may be merged via patient aggregate graph builder engine 210.

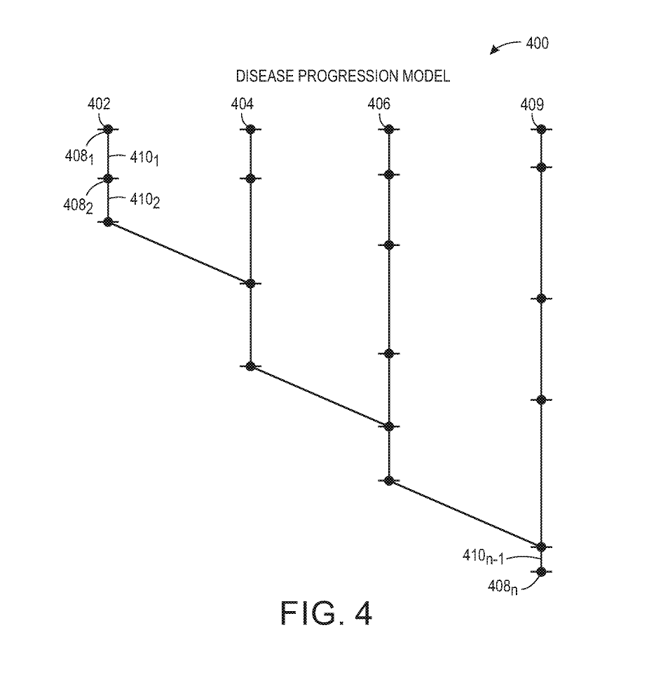

In one embodiment, the aggregate graph builder engine 210 generates a disease progression model by aggregating two or more timelines of two or more different patient profiles. In one embodiment, each timeline may be a DAG. An example of an illustration of an example of a disease progression model 400 is illustrated in FIG. 4.

In FIG. 4, the disease progression model 400 may be a combination of different patient timelines that can show how a disease has progressed, what treatments were administered, how patients responded, and the like. FIG. 4 illustrates how four patient timelines 402, 404, 406 and 409 are merged to form the disease progression model 400.

In one embodiment, each patient timeline 402, 404, 406 and 409 may include a plurality of nodes 408₁ to 408ₙ (herein referred to individually as a node 408 or collectively as nodes 408). The nodes 408 may represent an event that has occurred (e.g., a disease is diagnosed, a prescription is administered, a procedure is performed, a follow up is conducted, an examination was conducted, and the like). Each node 408 may be connected by a respective edge 4101 to 410ₙ₋₁ (herein referred to individual as an edge 410 or collectively as edges 410). Each edge 410 may represent a passing of an amount of time that connects two or more events represented by the nodes 408.

For example, the patient timeline 402 has three nodes 408, the patient timeline 404 has four nodes 408, the patient timeline 406 has six nodes 408, and the patient timeline 409 has six nodes 408. In one embodiment, the disease progression model 400 merges the patient timelines 402, 404, 406 and 409 to combine the experiences of several patients and capture the progression of the disease. For example, common nodes 408 (e.g., similar events) may be merged. For example, a first patient may have been diagnosed with cancer and a second patient may have been diagnosed with the same type of cancer at a later time. The nodes 408 that represent these events may be merged together and edges 410 may each connect to a particular node 408 that represents the diagnosis of cancer. As a result, two more patient timelines of previous patients can be combined to form the disease progression model 400 to understand how the disease has progressed among the patients.

It should be noted that the disease progression model may include other features that are not shown and is not limited to toplines, nodes, and edges. The disease progression model is also not limited to a specific number of events nor a specific number of patients.

In one embodiment, the disease progression model that is generated by the aggregate graph builder engine 210 may be used to determine the medical action that is to be executed by the medical determination engine 212. For example, a new patient may have a timeline generated based on his or her patient profile. The timeline of the new patient may then be compared to the disease progression model to determine a particular treatment or medicine to prescribe at a particular time, or progression, of the new patient. In one embodiment, the medical action to be executed that is determined by the medical determination engine 212 may be to provide a diagnosis or prescribe a treatment for a subsequent patient based on the disease progression model. In another example, the medical action to be executed that is determined by the medical determination engine 212 may be to provide information to assist patients, practitioners and the public in understanding various stages of disease, its symptoms, procedures patients have followed and repercussions of treatments faced.

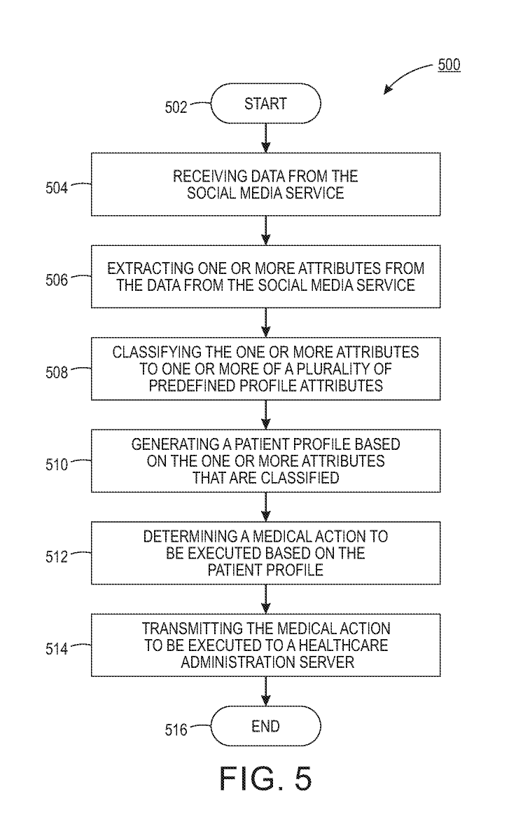

FIG. 5 illustrates a flowchart of an example method 500 for generating patient profiles via a social media service. In one embodiment, one or more steps or operations of a method 500 may be performed by the AS 104 (e.g., the PEP 106) or a computer as illustrated in FIG. 6 and discussed below.

At step 502 the method 500 begins. At step 504, the method 500 receives data from the social media service. In one embodiment, the data may be received in free text form and may be based on the natural language of the patient. In another embodiment, the data received may be for more than one patient. In one embodiment, data received from each post from the social media service are grouped from a given timestamp for a single patient or multiple patients. For example, where D is the dataset, consisting of K users with R records each, for a group of such R records for user k:

pk=kx₁ . . . kx_{R}.

In another embodiment, data may be collected from the original post in the social media service. For example, these posts from social media services may contain details about the problem, mention the medication that the user is taking, list the procedures the user has undergone, or provide personal information about the user's family and financial situation. In another embodiment, data is collected from the original post and related posts in social media service. For example, other users and patients having experience with a similar problem reply to an original post and this triggers further discussion between the patients and users.

In one embodiment, the method 500 preprocesses the data from the social media service by performing standard textual clean up steps. For example, all posts from a single user may be aggregated. In another example, the preprocessing may include tokenization, lower-case conversion, removal of stop words, Part-Of-Speech tagging, shallow parsing or chunking. In another embodiment, the method preprocesses the data using more than one preprocessing technique. For example, the data may be preprocessed by first performing sentence detection and second performing rule based tokenization.

At step 506, the method 500 may extract one or more attributes from the data from the social media service. At step 508, the method 500 may classify one or more attributes to one or more of a plurality of predefined profile attributes. For example, data may be classified into one or more of the pre-defined attributes using standard dictionary lookup techniques. In one embodiment, the dictionary lookup technique may use the Unified Medical Language System (UMLS), Systematic Nomenclature of Medicine (SNOMED) or RxNORM dictionaries for medical entities annotation. In another embodiment, the dictionary lookup technique may use a standard dictionary, such as Merriam-Webster's, New Oxford American, and the like. In one embodiment, the attribute may be based on the Unified Medical Language System (UMLS). For example, the attribute may be classified into pre-defined attributes, such as diseases/disorders, signs/symptoms, anatomical sites, procedures, or medications.

At step 510, the method 500 generates a patient profile based on the one or more attributes that are classified. In one embodiment, a patient profile generation engine may generate a patient profile by aggregating the attributes that are classified.

At step 512, the method 500 determines a medical action to be executed based on the patient profile. In one embodiment, a medical determination engine may be used to determine the medical action that is to be executed. In one embodiment, the medical action that is to be executed may be to recommend a patient group or a patient via endpoint device based on the patient profile.

In another embodiment, the patient profiles may be used to create timelines, present these timelines as DAGs, and generate a disease progression model. The medical action to be executed that is determined by the medical determination engine may be based on the disease progression model. In one embodiment, the medical action to be executed that is determined by the medical determination engine may be to provide a diagnosis or a treatment based on the disease progression model.

In one embodiment, the medical action to be executed that is determined by the medical determination engine may be monitoring a patient for a health risk based on similarity to a patient profile of another patient that has the health risk. In another embodiment, the medical action to be executed that is determined by the medical determination engine may be to take medical action (e.g., prescribe a particular drug, prescribe a particular therapy, prescribe a particular procedure, and the like) based on a prediction of an impact of a disease on a patient associated with the similarity to a patient profile of another patient that has the disease. For example, this prediction may be to predict mortality. In one embodiment, the medical action to be executed that is determined by the medical determination engine may be to use the similarity to a patient profile of another patient for risk stratification.

At step 514, the method 500 transmits the medical action to be executed to a health administration server. At step 516, the method 500 ends.

As a result, the embodiments of the present disclosure utilize social media data to understand a patient's medical condition, increase patient-to-patient communication for better peer support, and build a disease progression model to better understand a disease. The data is transformed from free formed text into generating patient profiles that can be used to identify the group of people who are similar to a patient's health issues and provide diagnosis and treatment options for subsequent patients.

Furthermore, the embodiments of the present disclosure improve the healthcare industry. For example, social media data is used to understand the patient and help them by recommending similar patients for better interactive communication. Additionally, the present disclosure provides easy information access to the patients and emotional support between patients. Furthermore, the present disclosure provides easy and quick access to care, reduces complications, reduces re-admission and recovery tracking, increases brand promotion and brand monitoring, and identifies high-risk patients. In another example, the disease progression model identifies various stages of the disease and helps doctors, patients and practitioners to better understand a patient's health condition and improve the quality of treatment. Additionally, the disease progression model may also be used for conditional anomaly detection methods, improving pharmaceutical research and development activity, optimizing treatment, and designing clinical guidelines.

FIG. 6 depicts a high-level block diagram of a computer that can be transformed to into a machine that is dedicated to perform the functions described herein. Notably, no computer or machine currently exists that performs the functions as described herein. As a result, the embodiments of the present disclosure improve the operation and functioning of the computer to generate a patient profile via a social media service, as disclosed herein.

As depicted in FIG. 6, the computer 600 comprises one or more hardware processor elements 602 (e.g., a central processing unit (CPU), a microprocessor, or a multi-core processor), a memory 604, e.g., random access memory (RAM) and/or read only memory (ROM), a module 605 for generating a patient profile via a social media service, and various input/output devices 606 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computer may employ a plurality of processor elements. Furthermore, although only one computer is shown in the figure, if the method(s) as discussed above is implemented in a distributed or parallel manner for a particular illustrative example, i.e., the steps of the above method(s) or the entire method(s) are implemented across multiple or parallel computers, then the computer of this figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 605 for generating a patient profile via a social media service (e.g., a software program comprising computer-executable instructions) can be loaded into memory 604 and executed by hardware processor element 602 to implement the steps, functions or operations as discussed above in connection with the example method 500. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 605 for generating a patient profile via a social media service (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for generating a patient profile via a social media service, the method comprising:
receiving, by a processor, data from the social media service;
extracting, by the processor, one or more attributes from the data from the social media service;
classifying, by the processor, the one or more attributes to one or more of a plurality of predefined profile attributes;
generating, by the processor, the patient profile based on the one or more attributes that are classified;
determining, by the processor, a medical action to be executed based on the patient profile; and
transmitting, by the processor, the medical action to be executed to a health administrator server (HAS).

2. The method of claim 1, wherein the data from the social media service is associated with a plurality of different patients.

3. The method of claim 1, wherein the determining the medical action comprises:
computing, by the processor, a similarity index between the patient profile and at least one additional patient profile.

4. The method of claim 3, wherein the medical action comprises:
monitoring, by the processor, a patient for a health risk based on the similarity index.

5. The method of claim 3, wherein the medical action comprises:
predicting, by the processor, an impact of a disease on a patient associated with the patient profile based on the similarity index.

6. The method of claim 3, wherein the medical action comprises:
recommending, by the processor, a patient group based on the similarity index.

7. The method of claim 6, wherein the recommending comprises:
causing, by the processor, the HAS to send an invitation to an endpoint device of the patient associated with the patient profile to join the patient group.

8. The method of claim 1, wherein the determining the medical action comprises:
creating, by the processor, a plurality of timelines based on a respective patient profile of a plurality of patient profiles; and
generating, by the processor, a disease progression model based on the plurality of timelines.

9. The method of claim 8, wherein the determining the medical action further comprises:
providing, by the processor, a diagnosis for a subsequent patient based on the disease progression model.

10. The method of claim 9, wherein the medical action comprises:
selecting, by the processor, a treatment for the subsequent patient based on the disease progression model.

11. A non-transitory computer-readable medium storing a plurality of instructions, which when executed by a processor, cause the processor to perform operations comprising:
receiving data from a social media service;
extracting one or more attributes from the data from the social media service; classifying the one or more attributes to one or more of a plurality of predefined profile attributes;
generating a patient profile based on the one or more attributes that are classified;
determining a medical action to be executed based on the patient profile; and
transmitting the medical action to be executed to a health administrator server (HAS).

12. The non-transitory computer-readable medium of claim 11, wherein the determining the medical action comprises:
computing a similarity index between the patient profile and at least one additional patient profile.

13. The non-transitory computer-readable medium of claim 12, wherein the medical action comprises:
monitoring a patient for a health risk based on the similarity index.

14. The non-transitory computer-readable medium of claim 12, wherein the medical action comprises:
predicting an impact of a disease on a patient associated with the patient profile based on the similarity index.

15. The non-transitory computer-readable medium of claim 12, wherein the medical action comprises:
recommending a patient group based on the similarity index.

16. The non-transitory computer-readable medium of claim 15, wherein the recommending comprises:
causing the HAS to send an invitation to an endpoint device of the patient associated with the patient profile to join the patient group.

17. The non-transitory computer-readable medium of claim 11, wherein the determining the medical action comprises:
creating a plurality of timelines based on a respective patient profile of a plurality of patient profiles; and
generating a disease progression model based on the plurality of timelines.

18. The non-transitory computer-readable medium of claim 17, wherein the determining the medical action further comprises:
providing a diagnosis for a subsequent patient based on the disease progression model.

19. The non-transitory computer-readable medium of claim 18, wherein the medical action comprises:
selecting a treatment for the subsequent patient based on the disease progression model.

20. A method for generating a patient profile via a social media service, the method comprising:
receiving, by a processor, data from the social media service for a plurality of different patients;
preprocessing, by the processor, the data for the plurality of different patients;
extracting, by the processor, one or more attributes for each one of the plurality of different patients from the data from the social media service;
classifying, by the processor, the one or more attributes to one of a plurality of predefined profile attributes for the each one of the plurality of different patients;
generating, by the processor, the patient profile for the each one of the plurality of different patients based on the one or more attributes that are classified;
extracting, by the processor, one or more events from the patient profile for the each one of the plurality of different patients; classifying, by the processor, the one or more events to one or more of a plurality of predefined profile events;
identifying, by the processor, temporal relationships among the one or more events that are classified;
creating, by the processor, a timeline based on the temporal relationships that are identified in the patient profile for the each one of the plurality of different patients;
generating, by the processor, a disease progression model based on the timeline of the each one of the plurality of different patients;
determining, by the processor, a medical action to be executed based on the disease progression model; and
transmitting, by the processor, the medical action to a health administration server to be executed.
